(19) United States
(12) Patent Application Publication
(10) Pub. No.: US 2009/0126154 A1
(43) Pub. Date: May 21, 2009

(54) HINGE APPARATUS

(75) Inventors: Ming-Han Lin, Taipei Hsien (TW); Chih-Heng Chien, Taipei Hsien (TW); Wei-Jia Liang, Taipei Hsien (TW); Shan-Yi Yang, Taipei Hsien (TW); Te-Hung Yin, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 11/944,390

(22) Filed: Nov. 21, 2007

(51) Int. Cl. E05F 1/12

(52) U.S. Cl. 16/286

(57) ABSTRACT

A hinge apparatus includes a hinge and a damper. The damper includes a damping shell, a damping body, an outer gasket and a pushing body, damping oil is filled in the damper. The damping shell has a cylinder-shaped shell body, a cover is formed in the top of the shell body, a sleeve is formed in the shell body, and an annual groove is defined between the shell body and the sleeve. The damping body has a bottom base, an annular sidewall, and a recess defined between the bottom base and the annular sidewall. The annular sidewall is received in the annual groove. The sleeve is received in the recess. Inner grooves are opened in the inside of the annular sidewall, outer grooves are opened in the outside of the annular sidewall. The outer gasket around the annular sidewall and below the outer grooves, the outer gasket is against the inside of the shell body. The pushing body is capable of pushing the damping body to rotate under the elastic force of the hinge.

### BACKGROUND OF THE INVENTION

1. Field of the Invention

This present invention relates to a hinge apparatus, and more particularly to a hinge apparatus preferably applicable to folding or unfolding an electric device such as a folding mobile phone, a portable computer and an electric pocket notebook.

2. The Related Art

Conventionally, a portable apparatus, such as a portable computer and a folding mobile phone, has a body and a display joined by two hinges arranged in two sides of the portable apparatus.

Referring to FIG. 1, a traditional hinge 10 includes a housing 3, a sliding cam 5, a rotating cam 6, a spring 4, a shaft 7, an E-ring 8 and a washer 9. Two curving surfaces 51 are formed in an upper end of the sliding cam 5, the curving surfaces 51 show a V-shape. Two sliding portions 61 are formed in a lower end of the rotating cam 6. The sliding cam 5 and the rotating cam 6 are accepted in the housing 3, the two sliding portions 61 is rotatably against the curving surfaces 51 of the sliding cam 5. The washer 9 covers the bottom of the housing 3. The spring 4 is accepted in the housing 3, one end of the spring 4 is against the washer 9, the other end of the spring 4 is against a lower end of the sliding cam 5. A lower end of the shaft 7 forms an annual groove, the shaft 7 passes through the rotating cam 6, the sliding cam 5, the spring 4 and the washer 9, and the E-ring 8 is accepted in the annual groove of the shaft 7.

The rotating cam 6 is fixed with the display of the portable computer, the housing 3 is fixed with the body of the portable computer. Generally, the two traditional hinges 10 are arranged in the two sides of the portable computer to link the body and the display. When the portable computer is unfolded or folded, the sliding portions 61 slides along the curving surfaces 51 quickly to a lower point of the curving surfaces 51, the rotating speed of the display around the body is quick, the display and the body are easy to be destroyed. If the traditional hinge 10 is arranged in a folding mobile phone, when the folding mobile phone is unfolded or folded, a display will strike a body of the folding mobile phone, the folding mobile phone will fall off the hand of the user carelessly.

### SUMMARY OF THE INVENTION

Accordingly, an object of the invention is to provide a hinge apparatus which meets the technical requirements in the above-mention hinge.

The hinge apparatus arranged in a folding electric device includes a hinge and a damper. The hinge is capable of producing or releasing an elastic force by rotating. The damper arranged coaxial with the hinge in the folding electric device includes a damping shell, a damping body, an outer gasket and a pushing body. The damping shell has a cylinder-shaped shell body, a cover is formed in the top of the shell body, a sleeve is formed in the shell body and arranged coaxial with the shell body, and an annual groove is defined between the shell body and the sleeve. The damping body showing a cylinder shape has a bottom base, an annular sidewall, and a recess defined between the bottom base and the annular sidewall. The annular sidewall is received in the annual groove of the damping shell. The sleeve of the damping shell is received in the recess. A plurality of inner grooves are opened in the inside of the annular sidewall. A plurality of outer grooves are opened in the outside of the annular sidewall. The outer gasket around the annular sidewall of the damping body and below the outer grooves, the outer gasket is against the inside of the shell body. The pushing body is capable of pushing the damping body to rotate under the elastic force of the hinge. Damping oil is filled in the damper.

As described above, the hinge apparatus is arranged in an electric device, the folding electric device has a display and a housing, while the electric device is unfolded or folded, the damper will prevent the display closing or separating the housing quickly to destroy the electric device.

### BRIEF DESCRIPTION OF THE DRAWINGS

The invention, together with its objects and the advantages thereof may be best understood by reference to the following description taken in conjunction with the accompanying drawings, in which:

FIG. 1 is an exploded perspective view of a traditional hinge apparatus;

FIG. 2 is a perspective view of a hinge apparatus according to the present invention, a damping body, a damping shell and a housing of the hinge apparatus are dissected partly;

FIG. 3 is an exploded perspective view of the hinge apparatus in FIG. 2;

FIG. 4 is a perspective view showing the damping shell of the hinge apparatus in FIG. 3;

FIG. 5 is another perspective view of the damping shell in FIG. 4;

FIG. 6 is a perspective view of the damping body of the hinge apparatus in FIG. 3;

FIG. 7 is another perspective view of the damping body in FIG. 6;

FIG. 8 is a perspective view of a pushing body of the hinge apparatus in FIG. 3;

FIG. 9 is another perspective view of the pushing body of the hinge apparatus in FIG. 8;

FIG. 10 is a perspective view of a rotating cam of the hinge apparatus in FIG. 3; and

FIG. 11 is a perspective view of a sliding cam of the hinge apparatus in FIG. 3.

### DETAILED DESCRIPTION OF THE PREFERRED EMBODIMENT

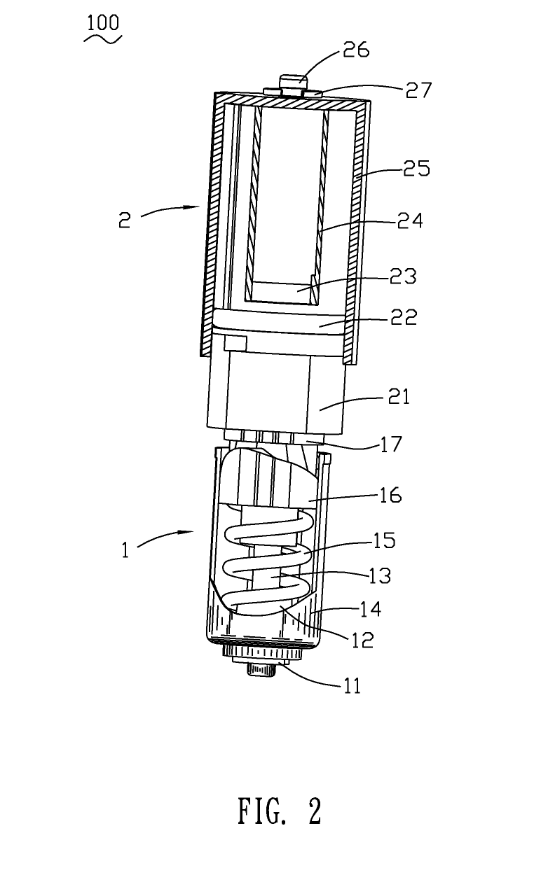

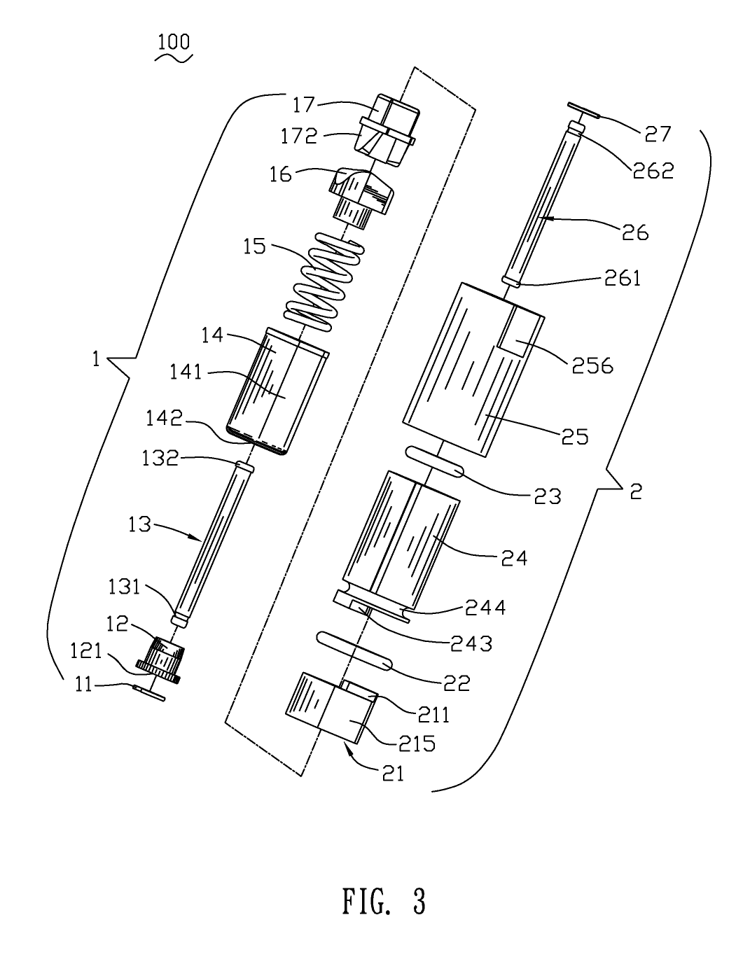

Please refer to FIGS. 2, and 3, a hinge apparatus 100 according to the invention is shown. The hinge apparatus 100 includes a hinge 1 and a damper 2.

The damper 2 includes a pushing body 21, a damping body 24, a damping shell 25 around the damping body 24. A damping shaft 26 passes through the pushing body 21, the damping body 24 and the damping shell 25, a clicking ring 27 is opened in the top of the damping shaft 26.

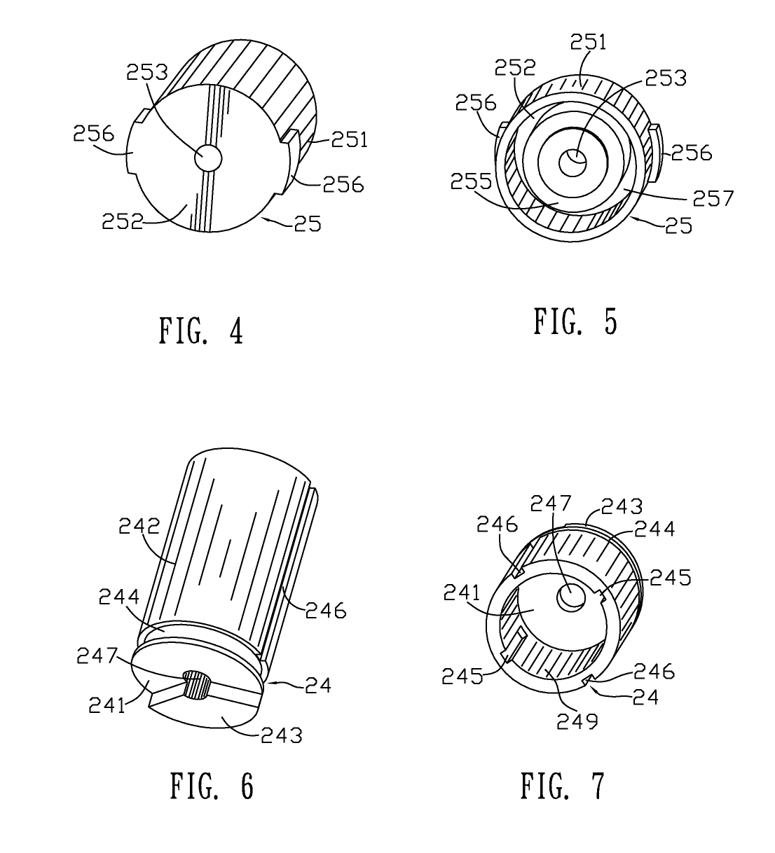

In FIGS. 4 and 5, the damping shell 25 has a shell body 251 showing a cylinder shape, a cover 252 forms in the top of the shell body 251 to seal the top of the shell body 251. A sleeve 255 forms in the shell body 251 and is coaxial with the shell body 251, so the shell body 251, the cover 252 and the sleeve 255 define an annual groove 257. The sleeve 255 has an axis hole 253 passing through two ends of the damping shell 25, the diameter of a lower portion of the sleeve 255 is less than the diameter of an upper portion of the sleeve 255. The length of the sleeve 255 is less than the length of the shell body 251. Two lumps 256 are arranged symmetrically at the outside of the shell body 251 and near to the cover 252. The lumps 256 can be inserted into two grooves arranged in an electric device to fasten the damping shell 25 in the electric device.

In FIGS. 2, 5, 6 and 7, the damping body 24 showing a cylinder shape has a bottom base 241 and an annular sidewall 242 extending vertically along the outside of the bottom base 241. The bottom base 241 and the annular sidewall 242 define a recess 249. A rotating hole 247 is opened in the bottom base 241 and connects to the recess 249. A fan-shaped projection 243 is arranged at one side of the bottom of the bottom base 241. An annular groove 244 is opened in an outer surface of the annular sidewall 242 and close to the bottom base 241. Two inner grooves 245 are opened lengthwise and symmetrically in the inner side of the annular sidewall 242, two outer grooves 246 are opened lengthwise and symmetrically in the outer side of the sidewall 242 and connect to the annular groove 244. The outer grooves 246 and the inner grooves 245 are disposed at intervals, each pair of the adjacent inner grooves 245 and outer grooves 246 have an approximately same space. The annular sidewall 242 is inserted into the annual groove 257.

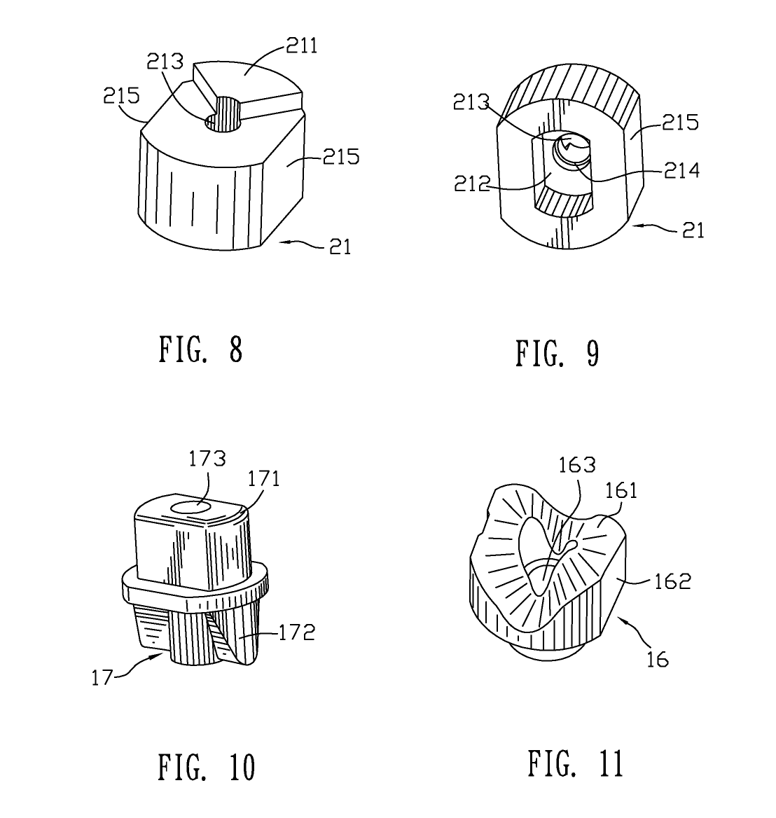

Referring to FIGS. 6, 8 and 9, the pushing body 21 shows a column shape. The bottom of the pushing body 21 sinks to form an accepting groove 212. The top of the pushing body 21 projects to form a fan-shaped lump 211 at one side thereof, the fan-shaped lump 211 can drive the fan-shaped projection 243 to rotate. A middle hole 213 is opened in the middle of the pushing body 21 and connects to the accepting groove 212. An annual lump 214 protrudes inward from the side of the middle hole 213. Two limiting planes 215 form symmetrically at two sides of the pushing body 21 for fixing the pushing body 21 in the electric device to rotate with the electric device together.

In FIGS. 2 and 3, the bottom of the damping shaft 26 projects outward to form a projecting ring 261, an annual slot 262 is opened in the top of the damping shaft 26. When the damping shaft 26 passes through the pushing body 21, the projecting ring 261 is against the annual lump 214, the top of the damping shaft 26 passes through the middle hole 213 of the pushing body 21, the rotating hole 247 of the damping body 24 and the axis hole 253 of the damping shell 25 to project out of the damping shell 25, the annual slot 262 is exposed outside the cover 252 of the damping shell 25, a C-ring 27 is accepted in the annual slot 262 of the damping shaft 26 and against the cover 252 of the damping shell 25, so the pushing body 21, the damping body 24 and the damping shell 25 are assembled together.

An outer gasket 22 covers the annular groove 244 of the damping body 24, while the damping body 24 assembled with the outer gasket 22 is accepted in the annual groove 257, the outer gasket 22 is against the shell body 251 of the damping shell 25. An inner gasket 23 is covered around the bottom of the sleeve 255, when the annual groove 257 accepts the damping body 24 assembled with the inner gasket 23, the sleeve 255 is accepted in the recess 249, the inner gasket 23 resists the top of the bottom base 241, and damping oil is filled between the shell body 251 and the sleeve 255.

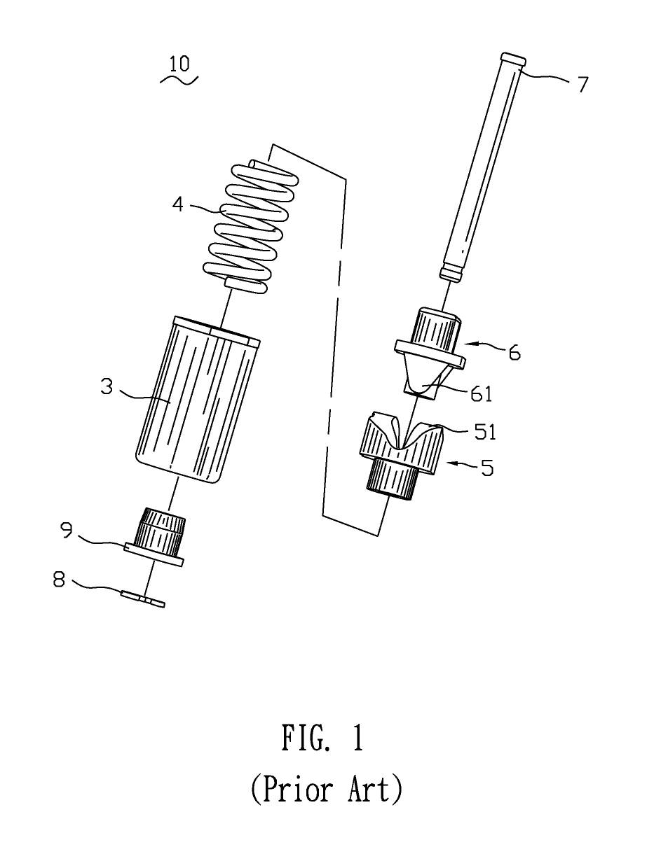

In FIG. 3, the hinge 1 includes an E-ring 11, a washer 12, a middle shaft 13, a housing 14, a spring 15, a sliding cam 16 and a rotating cam 17 arranged on the sliding cam 16. The hinge 1 is similar to the traditional hinge 10 in FIG. 1. Two limiting sides 141 are formed in the outside of the housing 14. A circular opening 142 is opened in the bottom of the housing 14. A cylindrical aperture 121 is arranged in the washer 12 lengthwise.

The washer 12 is inserted in the circular opening 142 and against the bottom of the housing 14. The spring 15 is accepted in the housing 14 and above the washer 12. The sliding cam 16 is accepted in the housing 14 and above the spring 15. The top of the sliding cam 16 has two curving surfaces 161. Two stop sides 162 are formed in the side of the sliding cam 16 and resist the inside of the limiting sides 141. An aperture 163 is opened along an axis of the sliding cam 16. An upper end of the rotating cam 17 forms a connecting portion 171, a lower end of the rotating cam 17 forms two sliding portions 172, the sliding portion 172 shows a V-shape, an axle hole 173 is opened in the rotating cam 17 from top to bottom. The sliding portions 172 resist the curving surfaces 161. The middle shaft 13 shows a longwise column shape, an annual notch 131 is opened in the bottom of the middle shaft 13, a protruding ring 132 is formed in the top of the middle shaft 13. For the diameter of the protruding ring 132 is larger than the diameter of the axle hole 173, the protruding ring 132 is against the top of the rotating cam 17. The bottom of the middle shaft 13 passes through the axle hole 173 of the rotating cam 17, the aperture 163 of the sliding cam 16, the spring 15, the circular opening 142 of the housing 14 and the cylindrical aperture 121 of the washer 12, then the E-ring 11 is located in the annual notch 131.

In this embodiment, the connecting portion 171 is accepted firmly in the accepting groove 212 of the pushing body 21 while the hinge apparatus 100 is arranged in the electric device. The pushing body 21 is arranged in a display of the electric device, the housing 14 and the damping shell 25 are arranged in a base of the electric device.

When the electric device is unfolded or folded, the pushing body 21 rotates with the display, the pushing body 21 drives the rotating cam 17, and the fan-shaped lump 211 rotates along the bottom base 241 of the damping body 24, the sliding portions 172 slide along the rising portions of the curving surfaces 161 of the sliding cam 16 respectively, then the sliding portions 172 slide along the dropping portions of the curving surfaces 161 respectively, the fan-shaped lump 211 resists and drives the fan-shaped projection 243, so the damping body 24 rotates in the annual groove 257 of the damping shell 25. For the viscosity of the damping oil filled between the shell body 251 and the sleeve 255, the damping body 24 rotates in the annual groove 257 slowly, the display is unfolded or folded softly, therefore, the electric device is not destroyed in the unfolded or folded process.

In another embodiment, the housing 14 and the connecting portion 171 of the rotating cam 17 are arranged in the base and the display symmetrically, and the pushing body 21 and the damping shell 25 are arranged in the base and the display. The limiting sides 141 are used to fasten firmly the housing 14 in the electric device.

As described above, the contact area between the damping body 24 and the damping oil is added by the inner grooves 245 and the outer grooves 246 respectively defined in the inside and outside of the damping body 24, therefore, when the pushing body 21 pushes the damping body 24, the damping body 24 rotates more softly, then the electric device can be unfolded or folded more reliably.

An embodiment of the present invention has been discussed in detail. However, this embodiment is merely a specific example for clarifying the technical contents of the present invention and the present invention is not to be construed in a restricted sense as limited to this specific example. Thus, the spirit and scope of the present invention are limited only by the appended claims.

What is claimed is:

1. A hinge apparatus arranged in a folding electric device, comprising:
a hinge, capable of producing or releasing an elastic force by rotating; and
a damper arranged coaxial with the hinge, having
a damping shell, having a cylinder-shaped shell body, a cover formed in the top of the shell body, a sleeve formed in the shell body and coaxial with the shell body, and an annual groove defined between the shell body and the sleeve,
a damping body showing a cylinder shape, having a bottom base, an annular sidewall, and a recess defined between the bottom base and the annular sidewall, the annular sidewall received in the annual groove of the damping shell, the sleeve of the damping shell received in the recess, inner grooves opened in the inside of the annular sidewall, outer grooves opened in the outside of the annular sidewall,
an outer gasket around the annular sidewall of the damping body and below the outer grooves, the outer gasket against the inside of the shell body, and
a pushing body, capable of pushing the damping body to rotate under the elastic force of the hinge.

2. The hinge apparatus as set forth in claim 1, further comprising a damping shaft passing through the damping shell and the damping body.

3. The hinge apparatus as set forth in claim 2, further comprising an inner gasket around the bottom of the sleeve, the inner gasket against the inside of the annular sidewall and below the inner grooves.

4. The hinge apparatus as set forth in claim 1, wherein the annular sidewall defines an annular groove below the outer groove therearound, the outer groove is opened lengthwise and connects the annular groove.

5. The hinge apparatus as set forth in claim 1, wherein the outer grooves and the inner grooves are disposed at intervals, each pair of the adjacent inner grooves and outer grooves have an approximately same space.
